(19) United States
(12) Patent Application Publication
(10) Pub. No.: US 2016/0209261 A1
(43) Pub. Date: Jul. 21, 2016

(54) VESSEL FLUID MEASUREMENT ASSEMBLIES AND RELATED SYSTEMS AND METHODS

(71) Applicant: SAVAGE SERVICES CORPORATION, Salt Lake City, UT (US)

(72) Inventor: Vincent Paul Lambert, Eagle Mountain, UT (US)

(21) Appl. No.: 14/997,045

(22) Filed: Jan. 15, 2016

Related U.S. Application Data
(60) Provisional application No. 62/104,449, filed on Jan. 16, 2015.

(51) Int. Cl. G01F 23/292; G01F 23/00

(52) U.S. Cl. CPC G01F 23/292; G01F 23/00

(57) ABSTRACT

Fluid measurement assemblies and related methods for measuring a fluid level within a vessel. In some embodiments, the assembly may comprise a container or housing for housing a non-contact fluid measurement device. The container may further comprise a fitting configured for coupling the non-contact fluid measurement device with a port of a vessel, such as a tanker car holding oil or another fossil fuel. The container may be configured to expose part of the assembly, such as a window, to an opening in a port to allow for sending a beam into the vessel for measuring a fluid level of the liquid or other fluid within the vessel.

### RELATED APPLICATIONS

This application claims the benefit under 35 U.S.C. §119(e) of U.S. Provisional Patent Application No. 62/104,449 filed Jan. 16, 2015 and titled “VEHICLE VESSEL MEASUREMENT ASSEMBLIES AND RELATED SYSTEMS AND METHODS,” which application is incorporated herein by reference in its entirety.

### SUMMARY

Disclosed herein are various devices, assemblies and methods for measuring the volume and/or capacity of a fluid within a vessel, such as, for example, oil in a tank car of a train. Some such embodiments and implementations may be useful, for example, to allow for determining a capacity, or at least an approximate capacity, of the tank car or other vessel without requiring a user to open and/or enter the vessel in some fashion. Some embodiments, may also, or alternatively, allow for such measurement without exposing the measurement device and/or the environment to vapors that may be present in the vessel.

In a more particular example of a fluid measurement assembly for measuring a fluid level within a vessel according to some embodiments, the assembly may comprise a container comprising at least one window; a non-contact fluid measurement device, which may be positioned within the container; and a fitting configured for coupling the non-contact fluid measurement device and/or assembly with a port of a vessel, such as an oil tank car or another vehicle vessel. In some embodiments, the fitting and/or the container may be configured to seal the non-contact fluid measurement device with respect to the port of the vessel to at least substantially prevent gases within the vessel from contacting the non-contact fluid measurement device during use. In some embodiments, the assembly may be configured to seal the vessel with respect to the external environment such that vapors in the vessel are not released during measurement.

In some embodiments, the fluid measurement assembly may be configured to expose the at least one window to an interior of the vessel after coupling the non- contact fluid measurement device with the port to allow the non-contact fluid measurement device to measure a fluid level within the vessel, such as by use of a valve, which may be either part of the fluid measurement assembly or may be part of the vessel port. In some embodiments, the valve may be operable by a combination of components from the vessel port and assembly. In some embodiments, The fluid measurement assembly may be configured to expose the at least one window to an interior of the vessel after coupling the non-contact fluid measurement device with the port by exposing the at least one window to a valve, and wherein, upon opening the valve, the at least one window is exposed to the interior of the vessel to allow the non- contact fluid measurement device to measure a fluid level within the vessel.

In some embodiments, the container may comprise a first window configured to be exposed to the interior of the vessel after coupling the non-contact fluid measurement device with the port to allow the non-contact fluid measurement device to measure a fluid level within the vessel; and a second window configured to allow a user to at least one of operate the non-contact fluid measurement device and obtain a reading from the non-contact fluid measurement device while the fluid measurement assembly is coupled with the port and without removing the non-contact fluid measurement device from the container.

In another example of a fluid measurement assembly for measuring a fluid level within a vessel according to some embodiments, the assembly may comprise a container; a non-contact fluid measurement device positioned within the container; and a fitting configured for coupling the non-contact fluid measurement device with a port of a vessel.

In some embodiments, the container may comprise one or more windows. The window(s) may comprise a transparent material, and the fluid measurement assembly may be configured to expose the window to an interior of the vessel after coupling the non-contact fluid measurement device with the port to allow the non-contact fluid measurement device to measure a fluid level within the vessel.

In some embodiments, the non-contact fluid measurement device may comprise a LASER, and the fluid measurement assembly may be configured such that, upon coupling the non-contact fluid measurement device with the port of the vessel, the LASER is configured to enter the vessel to measure a fluid level in the vessel.

In some embodiments, the fluid measurement assembly may be configured to seal the non-contact fluid measurement device with respect to the port of the vessel to at least substantially prevent gases within the vessel from contacting the non-contact fluid measurement device during operation. In some embodiments, the fluid measurement assembly may be configured to seal the non-contact fluid measurement device with respect to the surrounding environment to prevent, or at least substantially prevent, gases from the vessel from escaping the vessel during the measurement.

In some embodiments, the fluid measurement assembly may comprise an opening configured to be aligned with an opening in the port of the vessel after coupling the fluid measurement assembly with the port, wherein the container comprises a window, and wherein the window is positioned in line with the opening such that, upon coupling the fluid measurement assembly with the port, a beam from the non-contact fluid measurement device can extend through the window, through the opening, and into the vessel to allow for measuring the fluid level within the vessel.

In an example of a method for measuring a fluid level within a vessel accordingly to some implementations, the method may comprise coupling a fluid measurement assembly with a port of a vessel containing a fluid. The fluid measurement assembly may comprise a non-contact fluid measurement device; and a fitting configured for coupling the non-contact fluid measurement device with the port. The method may further comprise opening a valve to expose at least a portion of the non-contact fluid measurement device to the fluid within the vessel; taking a measurement of a level of the fluid within the vessel using the non-contact fluid measurement device without any direct contact between the non-contact fluid measurement device and the fluid; closing the valve; and removing the non-contact fluid measurement device from the port of the vessel.

In some implementations, the step of opening a valve to expose at least a portion of the non-contact fluid measurement device to the fluid within the vessel may comprise opening a valve on the port.

In some implementations, the fluid measurement assembly may further comprise a window, which may be made up of a transparent material. In some such implementations, the step of opening a valve to expose at least a portion of the non-contact fluid measurement device to the fluid within the vessel may comprise exposing the window to the fluid within the vessel.

In some such implementations, the step of taking a measurement of a level of the fluid within the vessel may comprise transmitting a beam through the window to a surface of the fluid; receiving a reflection of the beam through the window; and calculating the level of the fluid using an elapsed time between the transmitted beam and the reflected beam.

In some implementations, the fluid measurement assembly may be configured to seal the non-contact fluid measurement device with respect to the port of the vessel to at least substantially prevent gases within the vessel from contacting the non-contact fluid measurement device after the step of opening a valve to expose at least a portion of the non-contact fluid measurement device to the fluid within the vessel.

The features, structures, steps, or characteristics disclosed herein in connection with one embodiment may be combined in any suitable manner in one or more alternative embodiments.

### BRIEF DESCRIPTION OF THE DRAWINGS

The written disclosure herein describes illustrative embodiments that are non- limiting and non-exhaustive. Reference is made to certain of such illustrative embodiments that are depicted in the figures, in which:

FIG. 1 depicts a vehicle storage vessel comprising a rail tank car being used with a fluid measurement assembly according to some embodiments.

FIG. 2 is a close-up, perspective view of the fluid measurement assembly of FIG. 1.

FIG. 3 is a side elevation view of the fluid measurement assembly of FIGS. 1 and 2.

FIG. 4 is a perspective view of the fluid measurement assembly of FIGS. 1-3 shown decoupled from the rail tank car.

FIG. 5 is a lower perspective view of the container of the fluid measurement assembly of FIGS. 1-4 shown decoupled from the fitting of the fluid measurement assembly.

FIG. 6 is a close-up, perspective view of an alternative embodiment of a fluid measurement assembly coupled with a rail tank car.

FIG. 7 is a side elevation view of the fluid measurement assembly of FIG. 6.

FIG. 8 is a perspective view of the fluid measurement assembly of FIGS. 6 and 7 shown decoupled from the rail tank car.

FIG. 9 is a lower perspective view of the container of the fluid measurement assembly of FIGS. 6-8 depicting the opening of the assembly configured to be aligned with a similar opening, such as a valve-actuated opening, of a rail tank car port or another vessel port.

### DETAILED DESCRIPTION

A detailed description of apparatus, systems, and methods consistent with various embodiments of the present disclosure is provided below. It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In addition, while numerous specific details are set forth in the following description in order to provide a thorough understanding of the embodiments disclosed herein, some embodiments can be practiced without some or all of these details. Moreover, for the purpose of clarity, certain technical materials, structures, or operations that are known in the related art have not been shown or described in detail in order to avoid unnecessarily obscuring the disclosure.

Various embodiments of apparatus, methods, and systems are disclosed herein that relate to measuring the volume and/or capacity of a fluid within a vessel. More particularly, certain preferred embodiments and implementations relate to measuring liquids, such as crude oil, within a vehicle, such as tank car of a train or another such vessel. Some such embodiments and implementations may be useful, for example, to allow for determining a capacity, or at least an approximate capacity, of the tank car or other vessel without requiring a user to open and/or enter the vessel in some fashion.

This may be advantageous for a number of reasons. For example, rail cars containing crude oil are often assessed for capacity/volume by opening the vessel and using a stick, rod, tape measure, or another similar tool that is then inserted into the oil or other liquid within the car to the bottom of the car. The stick is then examined for residue and the length of the residue is used to approximate the capacity for and/or volume of oil in the car.

However, this solution is less than ideal for a variety of reasons. For example, it may be dangerous, or at least less preferred, to require a person to reach into a rail car. This solution may also be difficult to perform, imprecise, and prone to user error. Moreover, certain governmental regulations may prohibit or inhibit opening certain vessels to the atmosphere.

Thus, certain embodiments and implementations disclosed herein may provide for a coupling mechanism and/or container having a fluid measurement device coupled thereto in a manner that may allow for consistent measurement of a capacity and/or volume of a fluid within a vessel without requiring burdensome, dangerous, and perhaps prohibited manual measurements. In some embodiments, the container, fluid measurement device, and coupling mechanism may be combined as part of a fluid measurement assembly.

In some embodiments, one or more non-contact fluid measurement devices may be used, such as LASER, ultrasound, or RADAR devices, for example. A “non-contact fluid measurement device,” as used herein, should be interpreted to encompass any device that measures the volume and/or capacity of a liquid or other fluid without requiring direct contact between the device and the fluid. In some preferred embodiments, for example, a BOSCH® GLR225 device or a Leica DISTO™ E7400X device may be used as the non-contact fluid measurement device. Thus, in some embodiments, such devices may be mounted outside of the vessel, or within a port or window of the vessel, to allow for accessing measurements without requiring the vessel to be opened and/or entered in some manner.

In some embodiments, the non-contact fluid measurement device(s) may, as mentioned above, be placed within a box or other container to facilitate mounting the device(s) in or adjacent to the fluid vessel. Such container may also comprise mounting features that may be used to couple the container, and thereby couple the fluid measurement device, to a desired location on a vehicle vessel, such as on or near a pre-existing port of a rail car, for example. In some embodiments, the container may be sealed and/or may comprise a very rigid, durable material. In some embodiments, the container and/or an assembly including the container may be removably coupleable from the vessel, such as along an exterior surface of the vessel adjacent to a port formed within the vessel.

Because some non-contact fluid measurement devices are not suitable for use in flammable areas and may be prone to result in explosions, it may be desirable, or in some cases necessary, to keep the non-contact fluid measurement devices contained in a sealed container. For similar reasons, in some embodiments, the container may be explosion-proof. This may be particularly desirable for embodiments configured for use in connection with oil or other fossil fuels transported by rail cars. Thus, in some embodiments, the container may be made up of aluminum, stainless steel, or preferably another strong, rigid material.

One or more gaskets may also be used in order to obtain a desired seal or seals. Such seal(s) may be used to keep vapors from a storage vessel from exiting a rail car and/or entering the container. Other such seal(s) may be used to keep the non-contact fluid measurement device within the container and prevent vapors or other fluids, whether from within the storage vessel or the external environment, from entering the container and coming into contact with the non-contact fluid measurement device. The material used to form such gaskets or other sealing interfaces may comprise, for example, rubber, silicone, neoprene, nitrile rubber, polytetrafluoroethylene (PTFE) or another plastic polymer such as polychlorotrifluoroethylene (PCTFE).

Some embodiments may comprise one or more windows. Some such windows may allow a user to view the non-contact fluid measurement device in order to take a reading of the capacity and/or volume of a storage vessel. The same window, or another window, may allow a user to access a control panel or other similar instrumentation, screen, or other such feature such that a user can program, calibrate, transmit, or otherwise manipulate the non-contact fluid measurement device as needed without opening the container. Various materials may be used to form one or more of the windows of the device such as, for example, polycarbonate, thermoplastic materials, laminated glass, transparent ceramics, clear rubber, silicone, neoprene, nitrile rubber, polytetrafluoroethylene (PTFE), or another plastic polymer such as polychlorotrifluoroethylene (PCTFE).

Alternatively, some embodiments may be configured such that opening the container in some manner is required in order to access the device. Other such windows may be configured to allow a LASER or another similar wave or pulse to be emitted from the container down to the fluid that is to be measured. The same window or, alternatively, a separate window, may be used to receive a reflected wave/pulse to process the measurement.

Some embodiments may be configured to allow for wirelessly accessing measurement data stored on the non-contact fluid measurement device and/or companion storage or computing device. Thus, some embodiments may be configured to comprise or utilize an analog mobile communications network and/or a digital mobile communications network. In certain embodiments, the network connections may utilize IEEE's 802.11 standards, Bluetooth®, ultra-wide band (“UWB”), Zigbee®, and/or any other suitable communication protocol(s). Such embodiments may be configured to report fluid capacity/volume data upon query or, alternatively, may be configured to automatically transmit such data at certain intervals and/or time periods, such as after each measurement of a fluid level within a storage vessel.

Some embodiments may advantageously be coupled with a coupling device, such as a camlock unit, which may, in turn, be coupled with a rail car or another fluid storage vessel. In this manner, a measurement of oil or another fluid may be taken without ever exposing the atmosphere to the vapors within the storage vessel. For example, in some methods according to certain implementations of the invention, an assembly comprising a coupling device, container, and non-contact fluid measurement device may be coupled to an exterior surface of a storage vessel. The assembly may be coupled to an opening in the storage vessel such that the non-contact fluid measurement device may access the interior of the storage vessel.

Preferably, the assembly is coupled to a valve that is coupled to a port in the storage vessel. Thus, when a measurement of the volume/capacity of the vessel is desired, the valve, such as a ball valve, may be opened to expose the interior of the vessel to a pulse/wave of the non-contact fluid measurement device. Thus, as mentioned above, the assembly may, in some embodiments and implementations, be coupled to a cam lock or another similar fitting that is, in turn, configured to be coupled with a valve. In this manner, the combined fitting and assembly may be coupled to and removed from an existing valve without modification of the valve. However, as those of ordinary skill in the art will appreciate, it may be necessary to cut or otherwise modify the fitting so as to accommodate the assembly. In some embodiments, an existing fitting may remain on the railcar or other vehicle and a similar, in some cases identical, fitting may be modified and used as an adapter to allow for coupling a measurement device or assembly thereto.

In some such implementations, the assembly may be configured and positioned such that opening of the valve does not expose the interior of the storage vessel to the environment outside of the vessel. The valve may then be closed, after which the assembly may be removed from the exterior surface of the vessel without ever exposing the interior of the vessel, which may contain explosive and/or dangerous vapors, to the atmosphere. The assembly may be reapplied as desired in order to take further readings.

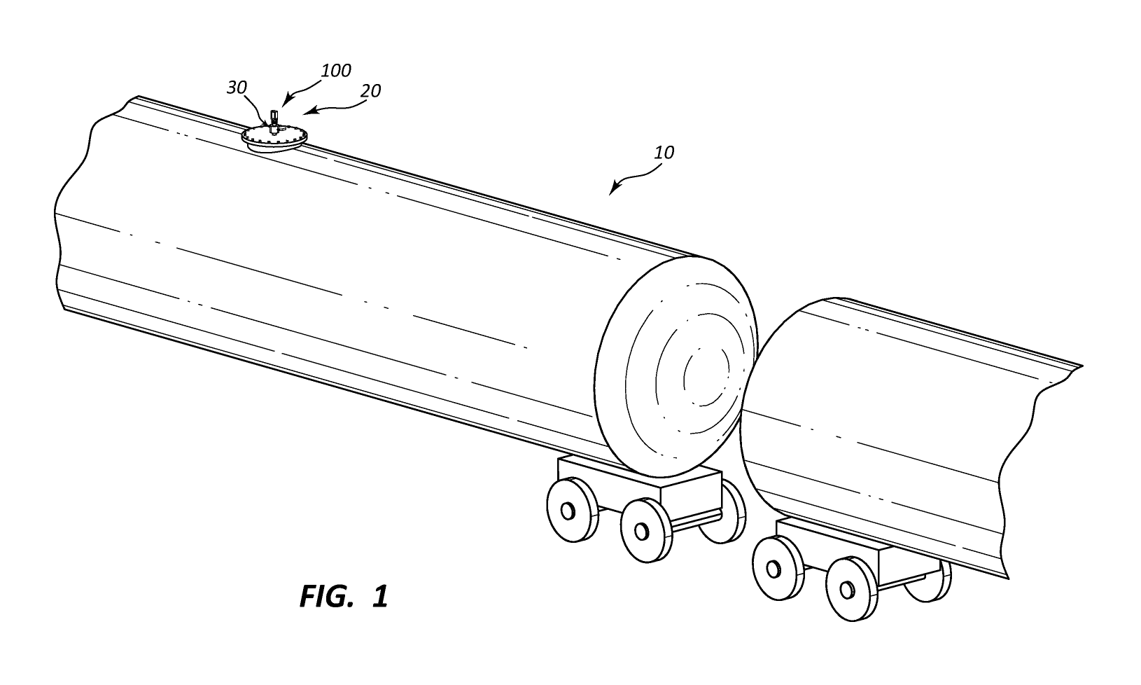

Additional details regarding certain preferred embodiments will now be described in greater detail with reference to the accompanying drawings. FIG. 1 depicts a rail car 10 comprising a storage vessel. This storage vessel may, for example, be configured to store/transport oil. Rail car 10 comprises a port 20. A valve 30 is positioned within port 20 such that an opening within valve 30 may be selectively opened, such as by rotating valve handle 35, in order to expose port 20 to the exterior of the storage vessel. A fluid measurement assembly 100 is coupled to valve 30. As discussed in greater detail below in conjunction with other figures, fluid measurement assembly 100 may comprise a coupling device, such as a camlock fitting, a container, and a non-contact fluid measurement device positioned within the container.

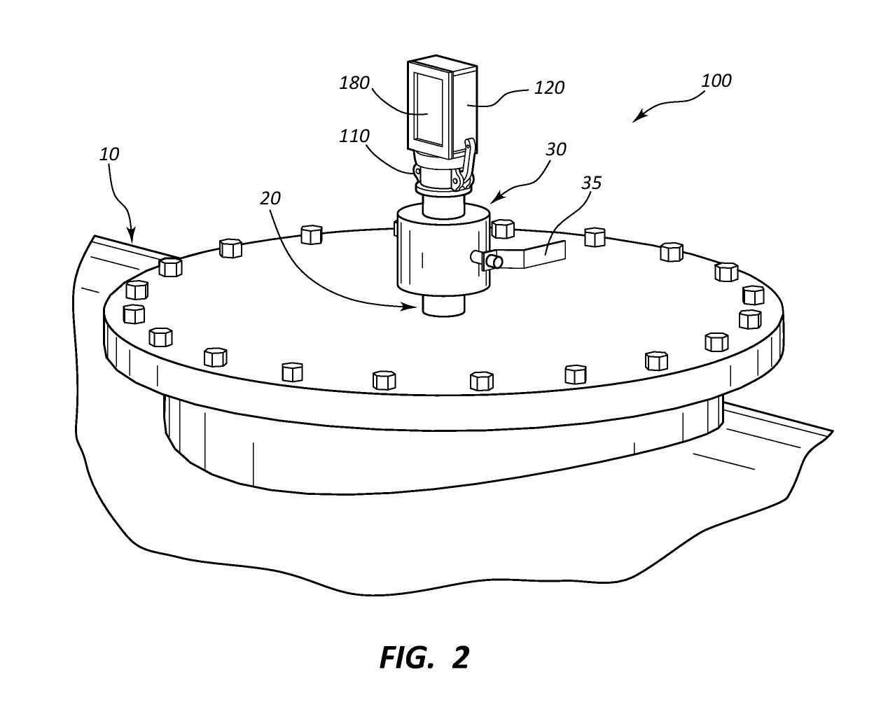

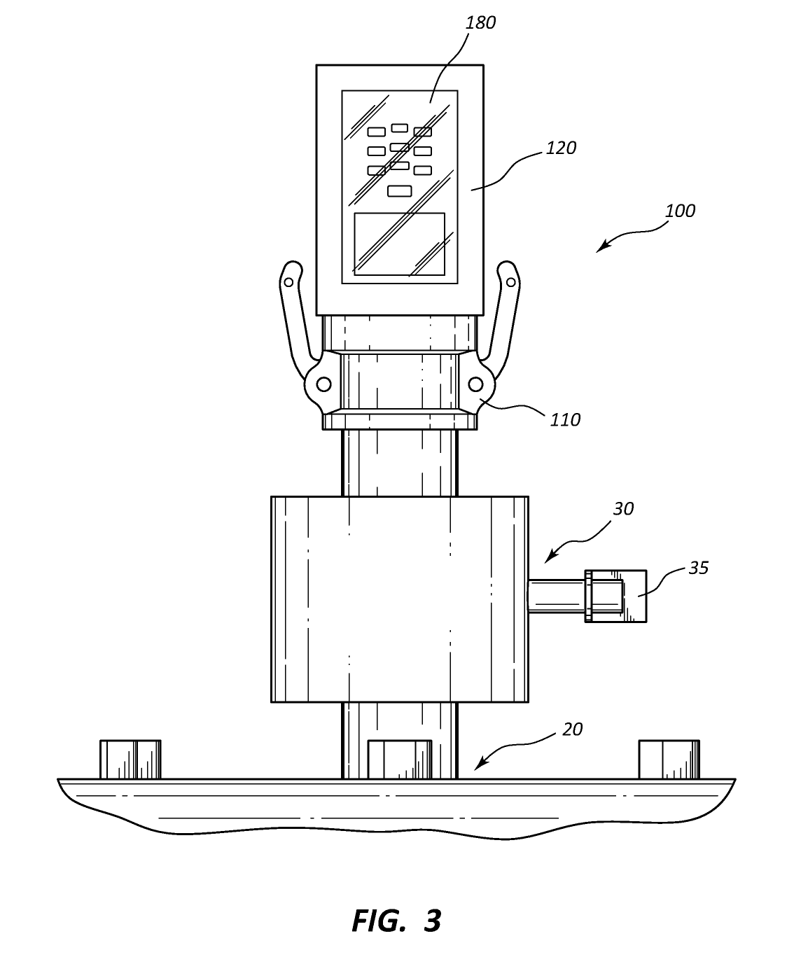

More particularly, as illustrated in the close-up views of FIGS. 2 and 3, fluid measurement assembly 100 comprises a fitting 110, a container 120, and a non-contact fluid measurement device 180 positioned within container 120. A window 125 may allow a user to operate the non-contact fluid measurement device 180 and/or obtain a reading from the non-contact fluid measurement device 180 while the fluid measurement assembly 100 is coupled with a vessel port and without removing the non-contact fluid measurement device 180 from the container 120.

Fitting 110 may comprise, for example, a female camlock fitting, such as a two-inch Dixon™ female cam lock fitting that is often used in connection with certain rail cars, or another coupling device configured for coupling to a port of a rail car or another vehicle storage vessel. In some implementations, the cam lock fitting or other coupling device may be modified to accommodate coupling with a fluid measurement assembly and/or non-contact fluid measurement device, as shown in FIGS. 2 and 3.

For example, in some implementations, a camlock fitting may be cut across the top to expose an opening extending to a valve. Alternatively, an existing camlock fitting may be drilled to expose an opening and/or valve within the fitting. Thus, the camlock fitting or other coupling device may, following such modification, be configured to allow for exposing the interior of the storage vessel upon opening of the valve, such as valve assembly 30. In alternative embodiments and implementations, an assembly may be manufactured with a built-in valve or a camlock fitting may be manufactured specifically to allow for exposing an adjacent valve and/or an interior of a storage vessel instead of modifying an existing fitting.

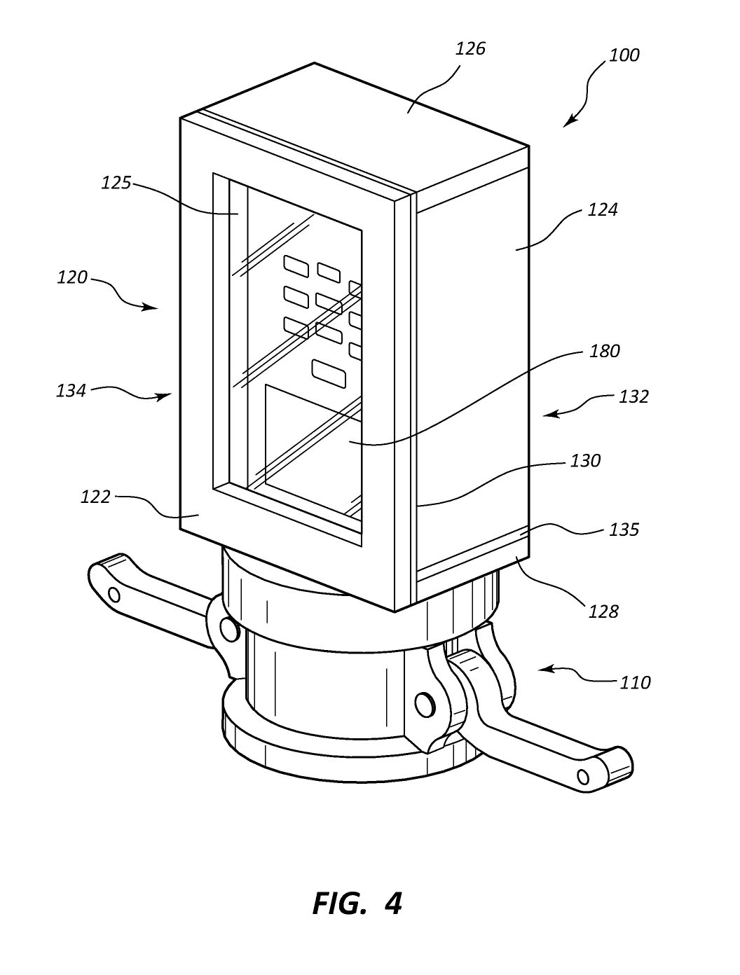

FIG. 4 is a perspective view depicting in greater detail various aspects of fluid measurement assembly 100. Thus, in the depicted embodiment container 120 may comprise various plates that may be coupled with one another to form a container. More particularly, container 120 comprises a front plate 122 comprising a window 125. Window 125 may allow for information from non-contact fluid measurement device 180 to be read by a user and/or may allow a user to manipulate non-contact fluid measurement device 180 (such as press buttons or access a touch screen, for example). In some embodiments, window 125 may therefore comprise a transparent, and/or flexible material, such as rubber, silicone, neoprene, nitrile rubber, polytetrafluoroethylene (PTFE), or another plastic polymer such as polychlorotrifluoroethylene (PCTFE). In alternative embodiments in which explosions and/or exposure to the non-contact fluid measurement device 180 is not a concern, window 125 may be open, thereby allowing free access to the non-contact fluid measurement device 180.

In embodiments comprising a sealed non-contact fluid measurement device 180, a sealing member 130 may be positioned adjacent to front plate 122. In some embodiments, sealing member 130 may comprise, for example, a gasket. Gasket 130 may be made up of any of a variety of suitable materials, such as rubber, silicone, neoprene, nitrile rubber, fiberglass, polytetrafluoroethylene (PTFE) or another plastic polymer such as polychlorotrifluoroethylene (PCTFE).

In some embodiments, a second front seal plate (not depicted) may be positioned behind front plate 122 such that the gasket 130 is positioned in between the first and second front plates. In such embodiments, the two front plates may be coupled to each other by way of, for example, bolts screws, rivets, other fasteners, or adhesives. The second front plate may be welded to one or more of the other plates described below. Alternatively, front plate 122 may be coupled directly to such other plates by any of the aforementioned means for coupling, or the container may be made up of one piece. For example, the container may be formed from a stock piece of aluminum or stainless steel.

As illustrated in FIG. 4, a non-contact fluid measurement device 180 is positioned within container 120 and behind window 125 such that various buttons, screens, or other similar features of non-contact fluid measurement device 180 are available for viewing and/or use. As also illustrated in this figure, the depicted embodiment of container 120 further comprises a bottom end plate 128. Another gasket 135 or other sealing member may be positioned in between bottom end plate 128 and one or more other plates and/or gaskets of the container 120. Thus, gasket 135 is positioned adjacent to side plate 124 and side plate 134, which is positioned opposite from side plate 124. Gasket 135 may also be positioned adjacent to a rear end plate 132. In some embodiments, rear end plate 132 need not comprise a window. However, if additional viewing and/or access to other sides of a particular non-contact fluid measurement device is needed, other windows may be provided as needed. A top end plate 126 may be coupled to one or more of side plates 124/134, front plate 122, and rear end plate 132 as desired.

In alternative embodiments, an integral box or other unit may be provided and one or more non-contact fluid measurement devices may be positioned inside without providing the specific configuration of plates depicted in the figures. Alternatively, certain plates and/or box pieces may be provided without providing each surface as a separate plate.

Container 120 may be welded or otherwise coupled with a fitting or another means for coupling a container for a non-contact fluid measurement device with a port of a vehicle vessel, such as fitting 110. As previously mentioned, fitting 110 may be similar or identical to a pre-existing fitting for a vehicle vessel port that has been modified in some manner to accommodate the container. In other words, fitting 110 may modified or otherwise comprise an adapter for coupling to another fitting of a railcar or another vehicle vessel. For example, a top surface of a fitting may be cut, drilled, and/or otherwise formed one or more holes within the fitting to allow for needed transmission and receipt of pulses/waves used by the non-contact fluid measurement device, in some cases through another, unmodified fitting that may already be used with the vessel port. Alternatively, the fitting may be custom-made to be coupleable to, or integral with, the container as an assembly.

Any of the various plates referenced herein may be welded together. Alternatively, the plates or other pieces making up the container may be coupled together by way of, for example, rivets, bolts, screws, and/or adhesives. Alternatively, the container 120 may be made of a single piece of steel, aluminum, or other suitable material, or may be made up of other pieces, rather than plates, that may be coupled together. However, welding may be preferred for strength in connection with certain embodiments, particularly those requiring isolation of the non-contact fluid measurement device due to safety concerns.

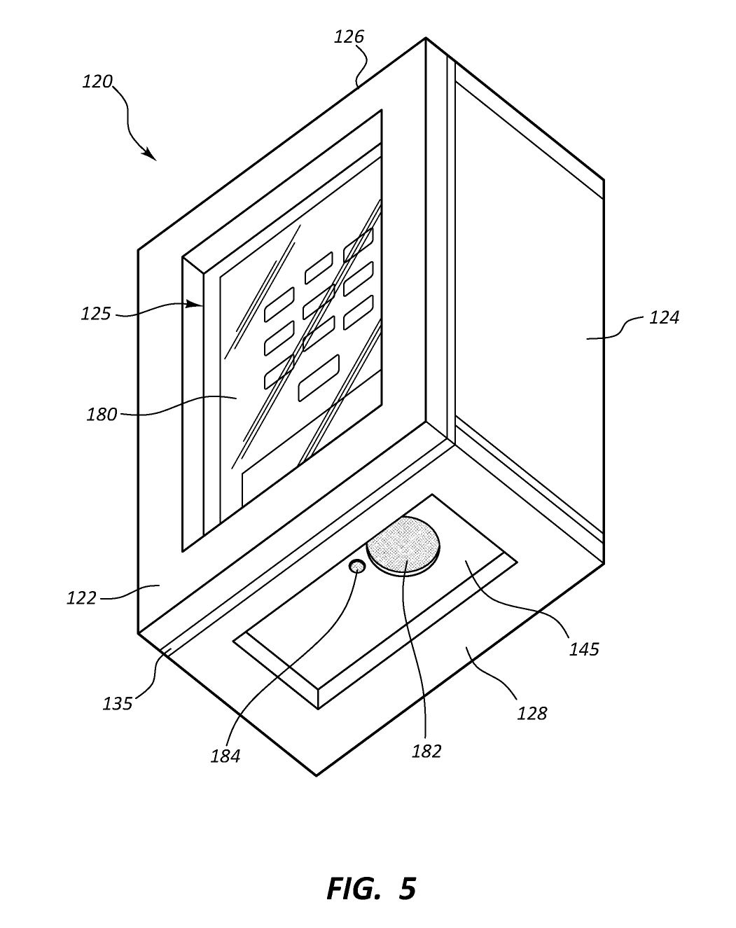

FIG. 5 depicts a lower perspective view of container 120 decoupled from fitting 110. In this figure, it can be seen that bottom end plate 128, like front plate 122, also comprises a window 145. In the depicted embodiment, window 145 may comprise a transparent material similar to window 125. However, in other embodiments, window 145 may be open.

FIG. 5 also depicts a bottom surface of non-contact fluid measurement device 180. This bottom surface comprises a measuring opening 182 and a transmission opening 184. A LASER or other transmitter may be positioned to direct a beam of light or another type of transmission through the transmission opening 184 to allow it to reach the surface of a fluid within a vehicle storage vessel. This pulse/beam may then be reflected back to the non-contact fluid measurement device 180 through the measuring opening 182. A timing circuit may then be used to measure the elapsed time and thereby calculate the distance, from which a fluid level/capacity/volume may be derived. As previously mentioned, the container 120 and/or an assembly, such as assembly 100, comprising the non-contact fluid measurement device 180, may be positioned so as to allow for sending this beam/pulse through a valve when the valve is opened. This may allow for measuring the fluid level without the need for ever exposing the interior of the vessel, which may comprise noxious vapors, to the environment and/or exterior of the vessel.

In some embodiments, instead of providing a rectangular window 145, one or more smaller openings may be formed in the bottom surface of container 120 that more precisely correspond with the needed transmission and/or measuring openings of the particular non-contact fluid measurement device being used.

Although a variety of non-contact fluid measurement devices may be used and, similarly, a variety of containers may be used, as those of ordinary skill in the art will appreciate, for purposes of illustration, a preferred embodiment using a BOSCH® GLR225 LASER distance measurement device may comprise a container that is approximately 2.75 inches wide, 4.5 inches high, and 1.75 inches deep. Such a container may be coupled with a two-inch female camlock fitting. Thus, if the particular plates set forth herein are used to manufacture the container, the front plate 122 may be about ¼ inch thick, 2¾ inches wide, and 4¼ inches long, and may comprise a frame that is about ½ inch thick. In embodiments comprising a second front seal plate, such plate may have similar dimensions to front plate 122 but may be half as thick. Similarly, rear end plate 132 may have similar dimensions but without an opening, and therefore without frame dimensions. The side plates 124 and 134 may be about 2 inches by about 4¼ inches. The top end plate 126 may be about 2¾ inches by about 2 inches. Finally, the bottom end plate 128 may have similar dimensions to the top end plate 126 but may comprise a frame. The thickness of the frame may be similar to that of front plate 122. Another example of a suitable non-contact fluid measurement device is a Leica DISTO™ E7400X LASER device.

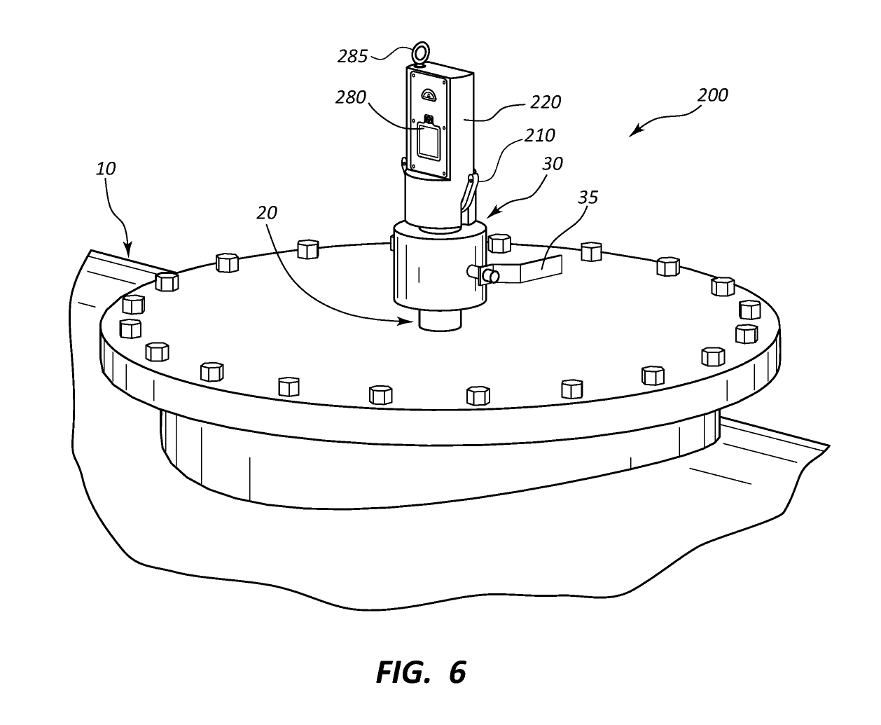

FIG. 6 is a close-up, perspective view of an alternative embodiment of a fluid measurement assembly 200 coupled with a rail tank car 10 comprising a storage vessel, which may be a storage vessel configured to store/transport oil or another fossil fuel, for example. Rail car 10 comprises a port 20. A valve 30 is positioned within port 20 such that an opening within valve 30 may be selectively opened, such as by rotating valve handle 35, in order to expose port 20 to the exterior of the storage vessel.

Fluid measurement assembly 200 is coupled to port 20. Like fluid measurement assembly 100, fluid measurement assembly 200 comprises a fitting 210, a container or housing 220, and a non-contact fluid measurement device 280 positioned within container 220. One or more windows may be positioned about container 220. For example, a window 225 may allow a user to operate the non-contact fluid measurement device 280 and/or obtain a reading from the non-contact fluid measurement device 280 while the fluid measurement assembly 200 is coupled with port 20 and without removing the non-contact fluid measurement device 280 from the container 220.

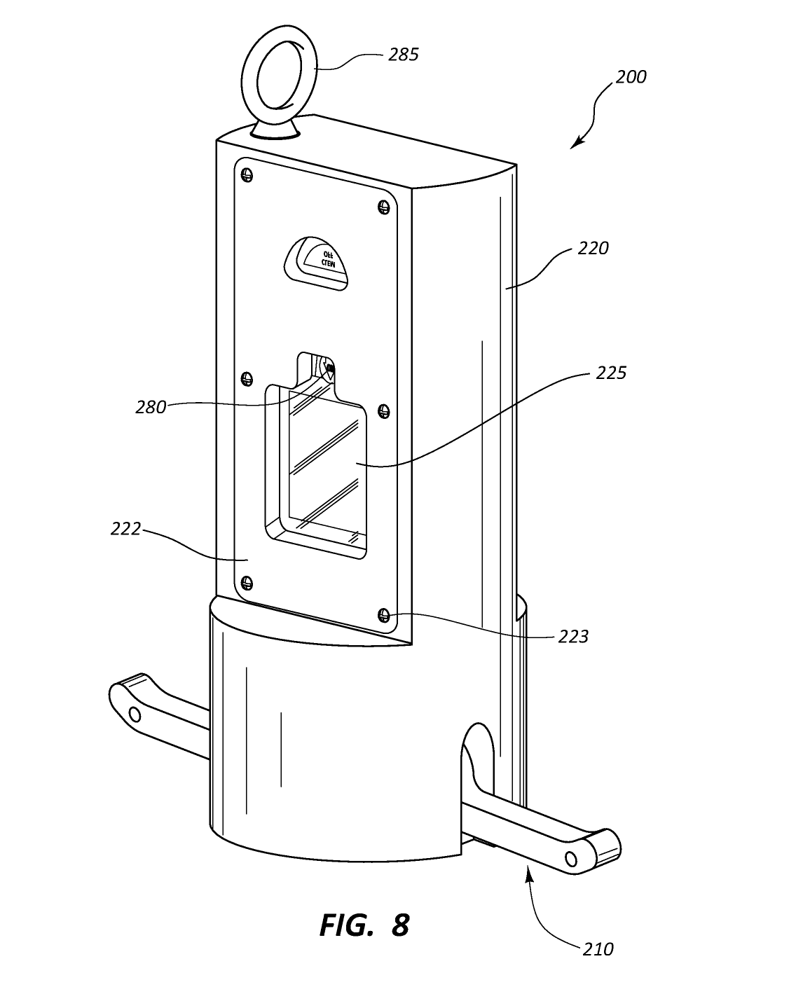

Unlike fluid measurement assembly 100, fluid measurement 200 may comprise a window 225 positioned within a removable front plate 222. Thus, as best shown in FIG. 8, window 225 may be positioned within front plate 222, which may be coupled to container 220. In some embodiments, window 225 may comprise a transparent, and/or flexible material, such as rubber, silicone, neoprene, nitrile rubber, polytetrafluoroethylene (PTFE), or another plastic polymer such as polychlorotrifluoroethylene (PCTFE), which may allow for viewing a display on non- contact fluid measurement device 280, manipulating a control panel, and/or may provide a vapor seal and/or protection against explosions.

Front plate 222 may be removably coupled to container 220. For example, in the depicted embodiment, front plate 222 may be coupled to container 220 using one or more fasteners 223, such as rivets, screws, bolts, and the like. In some embodiments, a similar removable plate (not shown in drawings) may be provided on the rear side of container 220. This plate may, for example, allow for removal and/or replacement of batteries.

Fitting 210 may comprise, for example, a female camlock fitting, such as a two-inch Dixon™ female cam lock fitting that is often used in connection with certain rail cars, or another coupling device configured for coupling to a port of a rail car or another vehicle storage vessel. In fluid measurement assembly 200, this female camlock fitting 210 is built into the housing or container 220 within which the non-contact fluid measurement device 280 is positioned. In some embodiments, container 220 may comprise a vapor-tight case and/or an explosion-proof case for reasons described above.

Fluid measurement assembly 200 further comprises an eyebolt 285, which may allow for coupling to a carabineer or other similar device for storing and/or transporting the assembly 200. In embodiments comprising a sealed non-contact fluid measurement device 280, one or more sealing members or gaskets may be provided, as needed, in order to provide suitable protection and/or a suitable vapor seal.

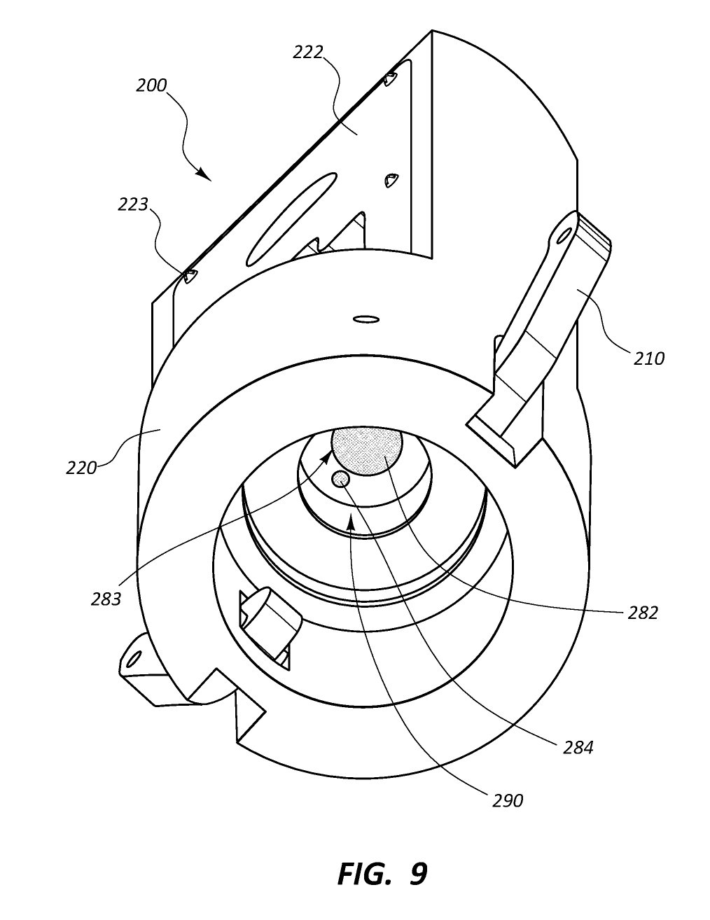

FIG. 9 is a lower perspective view of fluid measurement assembly 200. In this figure, it can be seen that an opening 290 is formed in the bottom of container 220. Opening 290 can be aligned with an opening in a port of a vessel, such as port 20, after coupling the fluid measurement assembly 200 with the port. As previously mentioned, in some embodiments and implementations, the port opening may comprise a valve, such as a ball valve. Thus, by coupling the fluid measurement assembly 200 with a port of a vessel, a window of container 220, such as windows 282 and 284, which are aligned with opening 290, may be positioned in line with the opening of the port such that, upon coupling the fluid measurement assembly 200 with the port, a beam from the non-contact fluid measurement device 280 can extend through one of the windows, through the port opening, and into the vessel to allow for measuring the fluid level within the vessel.

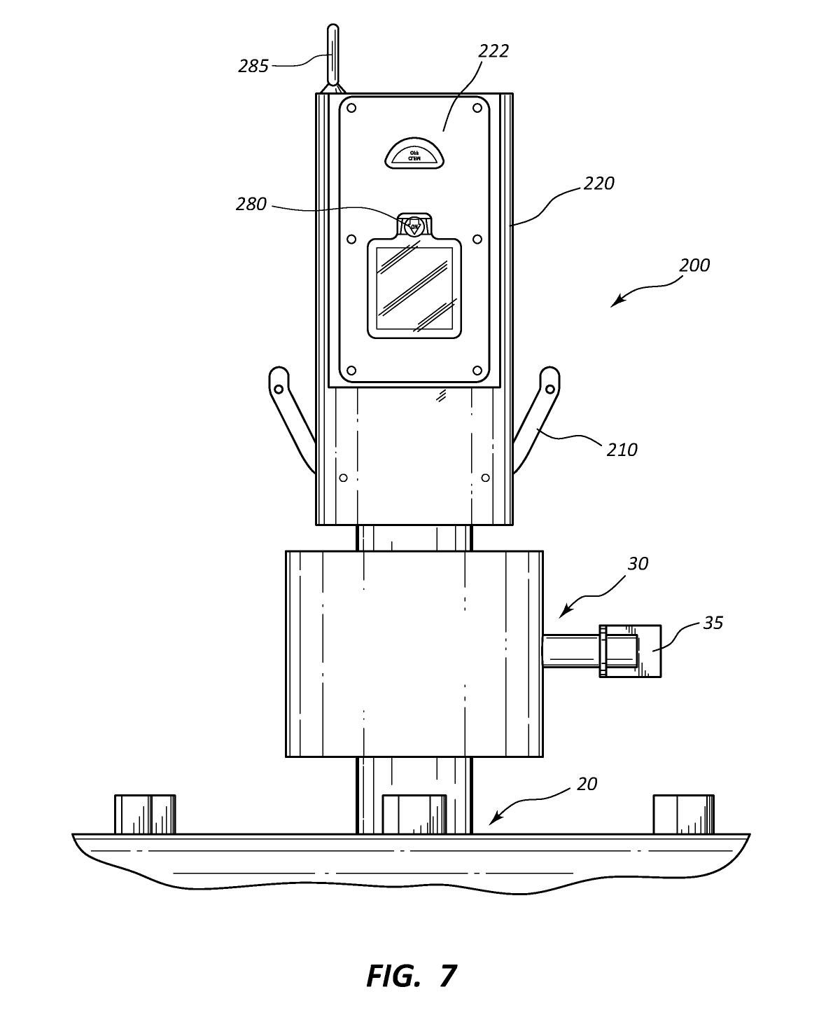

More particularly, with respect to the embodiment depicted in FIGS. 6-9, a LASER or another suitable transmitter from non-contact fluid measurement device 280 may be positioned to direct a beam of light or another type of beam through a transmission window 284 to allow it to reach the surface of a fluid within a vehicle storage vessel. This beam may then be reflected back to the non-contact fluid measurement device 280 through a measuring or beam receipt window 282. A timing circuit may then be used to measure the elapsed time and thereby calculate the distance, from which a fluid level/capacity/volume may be derived. As previously mentioned, assembly 200 may be positioned so as to allow for sending this beam through a valve when the valve is opened. The valve may be an existing valve, such as a ball valve, that is part of a vessel port. Alternatively, the valve may be built into assembly 200 if desired.

Windows 282 and/or 284 may comprise a transparent material, as previously mentioned, or may be open. In some embodiments, one or both of windows 282 and 284 may comprise a lens, such as a polycarbonate lens, which may aid in directing and/or receiving respective measurement beams in a desired manner. In some embodiments, one or more of the windows, such as window 282, may have a secondary lens positioned behind it, such as, for example, a secondary polycarbonate lens. In some such embodiments, the secondary lens may be about 2.2 mm thick and about 50 mm in diameter. However, in certain preferred embodiments, unlike window 225, windows 282 and/or 284 need not be made up of a pliable material, such that typically a user would not need to physically interact with these lower beam transmission/receipt windows.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. The scope of the present invention should, therefore, be determined only by the following claims.

1. A fluid measurement assembly for measuring a fluid level within a vessel, comprising:
a container comprising at least one window;
a non-contact fluid measurement device positioned within the container; and
a fitting configured for coupling the non-contact fluid measurement device with a port of a vessel, wherein at least one of the fitting and the container is configured to seal the non-contact fluid measurement device with respect to the port of the vessel to at least substantially prevent gases within the vessel from contacting the non-contact fluid measurement device, and wherein the fluid measurement assembly is configured to expose the at least one window to an interior of the vessel after coupling the non-contact fluid measurement device with the port to allow the non-contact fluid measurement device to measure a fluid level within the vessel.

2. The fluid measurement assembly of claim 1, wherein the fluid measurement assembly is configured to expose the at least one window to an interior of the vessel after coupling the non-contact fluid measurement device with the port by exposing the at least one window to a valve, and wherein, upon opening the valve, the at least one window is exposed to the interior of the vessel to allow the non-contact fluid measurement device to measure a fluid level within the vessel.

3. The fluid measurement assembly of claim 2, wherein the valve is part of the fluid measurement assembly.

4. The fluid measurement assembly of claim 1, wherein the vessel comprises a vehicle vessel.

5. The fluid measurement assembly of claim 4, wherein the vessel comprises a tank car of a train.

6. The fluid measurement assembly of claim 1, wherein the container comprises:
a first window configured to be exposed to the interior of the vessel after coupling the non-contact fluid measurement device with the port to allow the non-contact fluid measurement device to measure a fluid level within the vessel; and
a second window configured to allow a user to at least one of operate the non-contact fluid measurement device and obtain a reading from the non-contact fluid measurement device while the fluid measurement assembly is coupled with the port and without removing the non-contact fluid measurement device from the container.

7. A fluid measurement assembly for measuring a fluid level within a vessel, comprising:
a container;
a non-contact fluid measurement device positioned within the container; and
a fitting configured for coupling the non-contact fluid measurement device with a port of a vessel.

8. The fluid measurement assembly of claim 7, wherein the container comprises a window, wherein the window comprises a transparent material, and wherein the fluid measurement assembly is configured to expose the window to an interior of the vessel after coupling the non-contact fluid measurement device with the port to allow the non-contact fluid measurement device to measure a fluid level within the vessel.

9. The fluid measurement assembly of claim 8, wherein the non-contact fluid measurement device comprises a LASER, and wherein the fluid measurement assembly is configured such that, upon coupling the non-contact fluid measurement device with the port of the vessel, the LASER is configured to enter the vessel to measure a fluid level in the vessel.

10. The fluid measurement assembly of claim 7, wherein fluid measurement assembly is configured to seal the non-contact fluid measurement device with respect to the port of the vessel to at least substantially prevent gases within the vessel from contacting the non-contact fluid measurement device during operation.

11. The fluid measurement assembly of claim 10, wherein the fluid measurement assembly is configured to seal the non-contact fluid measurement device with respect to the surrounding atmosphere to at least substantially prevent gases in the atmosphere from contacting the non-contact fluid measurement device during operation.

12. The fluid measurement assembly of claim 7, wherein the fluid measurement assembly further comprises an opening configured to be aligned with an opening in the port of the vessel after coupling the fluid measurement assembly with the port, wherein the container comprises a window, and wherein the window is positioned in line with the opening such that, upon coupling the fluid measurement assembly with the port, a beam from the non-contact fluid measurement device can extend through the window, through the opening, and into the vessel to allow for measuring the fluid level within the vessel.

13. A method for measuring a fluid level within a vessel, the method comprising the steps of:
coupling a fluid measurement assembly with a port of a vessel containing a fluid, wherein the fluid measurement assembly comprises:
a non-contact fluid measurement device; and
a fitting configured for coupling the non-contact fluid measurement device with the port;
opening a valve to expose at least a portion of the non-contact fluid measurement device to the fluid within the vessel;
taking a measurement of a level of the fluid within the vessel using the non-contact fluid measurement device without any direct contact between the non-contact fluid measurement device and the fluid;
closing the valve; and
removing the non-contact fluid measurement device from the port of the vessel.

14. The method of claim 13, wherein the vessel comprises a tanker of a train.

15. The method of claim 13, wherein the fluid comprises a liquid.

16. The method of claim 15, wherein the liquid comprises a fossil fuel.

17. The method of claim 13, wherein the step of opening a valve to expose at least a portion of the non-contact fluid measurement device to the fluid within the vessel comprises opening a valve on the port.

18. The method of claim 13, wherein the fluid measurement assembly further comprises a window made up of a transparent material, wherein the step of opening a valve to expose at least a portion of the non-contact fluid measurement device to the fluid within the vessel comprises exposing the window to the fluid within the vessel, and wherein the step of taking a measurement of a level of the fluid within the vessel comprises:
transmitting a beam through the window to a surface of the fluid;
receiving a reflection of the beam through the window; and
calculating the level of the fluid using an elapsed time between the transmitted beam and the reflected beam.

19. The method of claim 18, wherein the beam comprises a LASER beam.

20. The method of claim 13, wherein the fluid measurement assembly is configured to seal the non-contact fluid measurement device with respect to the port of the vessel to at least substantially prevent gases within the vessel from contacting the non-contact fluid measurement device after the step of opening a valve to expose at least a portion of the non-contact fluid measurement device to the fluid within the vessel.
